(19) United States
(12) Patent Application Publication
(10) Pub. No.: US 2014/0121025 A1
(43) Pub. Date: May 1, 2014

(54) METHOD AND APPARATUS FOR ASYNCHRONOUS MOBILE MULTI-PLAYER GAMING

(71) Applicant: Nob Hill Studio Limited, Beijing (CN)

(72) Inventor: David Wanqian LIU, South San Francisco, CA (US)

(21) Appl. No.: 13/945,789

(22) Filed: Jul. 18, 2013

Related U.S. Application Data
(60) Provisional application No. 61/719,306, filed on Oct. 26, 2012.

(51) Int. Cl. A63F 13/12

(52) U.S. Cl. CPC A63F 13/12
USPC 463/42

(57) ABSTRACT

An asynchronous, multiplayer game provides a user interface (UI) to a mobile device for asynchronous multiplayer gaming. By way of the UI, a team opens a game by selecting an opponent and provides notice to its team members of the newly-opened game. After team members join the game, opponents trade strategic and tactical moves asynchronously. In an embodiment, opposing guilds fight wars against each other to occupy fortresses held by an opponent and capture the opponent's rations.

### CROSS REFERENCE TO RELATED APPLICATIONS

This application claims benefit of U.S. provisional patent application Ser. No. 61/719,306, filed Oct. 26, 2012, the entirety of which is incorporated herein by this reference thereto.

### TECHNICAL FIELD

This invention relates to mobile gaming. More specifically, the invention relates to a method and apparatus for asynchronous mobile multi-player gaming.

### BACKGROUND

Massively-multiplayer online games (MMOG) enjoy extraordinary popularity. The earliest of these games originated in the early- and mid-1970s and actually predate the Internet. The earliest multi-player computer games were played between two parties, each using a computer that was directly connected to the other by means of a serial cable. In the mid- and late 1970s, games appeared that could be played over ARPANET, which was a wide-area network developed by the Advanced Research Projects Agency.

In part due to rapidly proliferating ownership of personal computers and the increasing availability of modems, Multi-User Dungeon (MUD) was played by players who logged onto online bulletin boards hosted on proprietary networks such as COMPUSERVE and DELPHI. Many modern commercial games have millions of subscribers and can host many thousands of players at a single time.

As online games have become more sophisticated and complex, they have evolved into online video games, providing players engaging virtual worlds that are rendered using high-quality digital graphics and sound. A key feature of all multiplayer online games, however, is that all play is done in real time. Exclusive real-time game play means that players must be online to play for the entire duration of their period of game play.

Multiplayer online gaming is known for the inordinate amounts of time players devote to it. For some, a single session of game play may last many hours, and even days. However, because a fundamental feature of the games is that play takes place in real time, there seems no way of avoiding the commitment of large amounts of time to play. Additionally, massively-multiplayer online games (MMPOGs) are ordinarily played by way of conventional computers. Thus, the player is tied to a computer during game play.

### SUMMARY

A mobile, asynchronous multiplayer game provides a user interface (UI) to a mobile device for asynchronous multiplayer gaming. By way of the UI, a team opens a game by selecting an opponent and provides notice to its team members of the newly-opened game. After team members join the game, opponents trade strategic and tactical moves asynchronously. In an embodiment, opposing guilds fight wars against each other to occupy fortresses held by an opponent and capture the opponent's rations.

### BRIEF DESCRIPTION OF THE DRAWINGS

FIG. 1 provides a diagram of a machine in the exemplary form of a computer system within which a set of instructions, for causing the machine to perform any one of the methodologies discussed herein below, may be executed;

FIG. 2 provides a diagram of a client-server architecture across which a mobile gaming device for asynchronous multi-player gaming may be implemented;

FIG. 3 provides a schematic block diagram of a mobile gaming device;

FIG. 4 provides a flow diagram of the game play for an asynchronous multiplayer guild game played by way of a plurality of mobile gaming devices;

FIGS. 5-12 show a plurality of screen shots from a user interface (UI) to a mobile gaming device, including:

FIG. 5: a Guild home page;

FIG. 6: a Guild ward page;

FIG. 7: a declaration of war screen;

FIG. 8: a challenge result preview screen;

FIG. 9: a call for guild members to attend a war screen;

FIG. 10: a battle result preview screen;

FIG. 11: messages announcing a battle result screen; and

FIG. 12: messages announcing a war result screen.

### DETAILED DESCRIPTION

A mobile, asynchronous multiplayer game provides a user interface (UI) to a mobile device for asynchronous multiplayer gaming. By way of the UI, a team opens a game by selecting an opponent and provides notice to its team members of the newly-opened game. After team members join the game, opponents trade strategic and tactical moves asynchronously. In an embodiment, opposing guilds fight wars against each other to occupy fortresses held by an opponent and capture the opponent's rations.

The game is an asynchronous multi-player game. That is, the sides interact with each other, but asynchronously, rather than in real time as in prior-art multiplayer games. For purposes of illustration and example, game play is described herein from the point of view of one side. The sides compete and interact, but asynchronously. Each side is comprised of a guild, where each guild includes multiple players. An attacking guild stages a series of attacks on a defending guild. These attacks are noted in a server and are confirmed to the attacking guild. When the attack is complete, the defending guild is notified by the server if the attack has been successful, and the defending guild has been defeated; or if the attacks have been unsuccessful, and the defending guild has survived the attack. Thus, game play proceeds with a series of guild coordinated attacks, followed by a result.

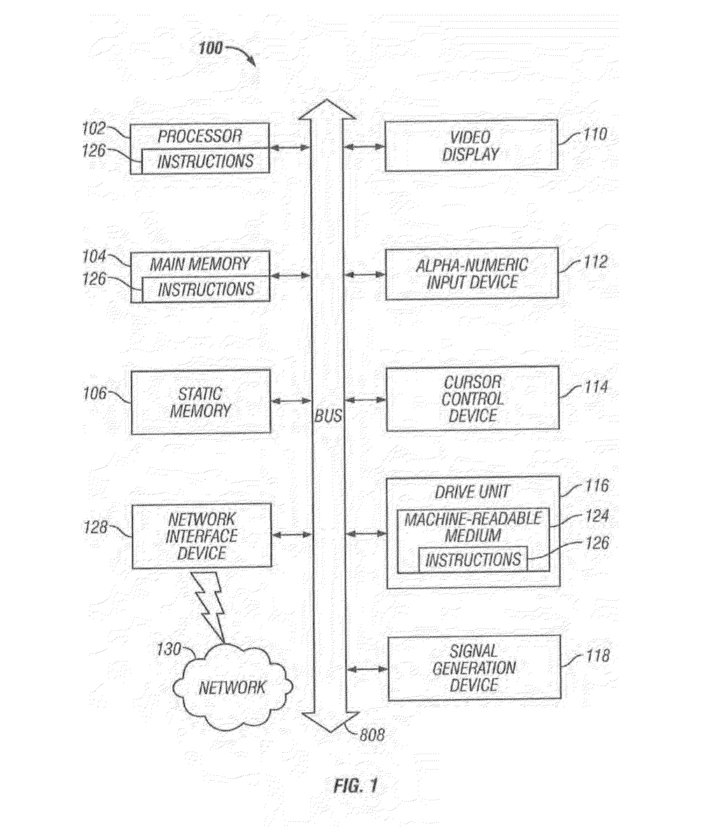

Referring now to FIG. 1, shown is a diagrammatic representation of a machine in the exemplary form of a computer system 100 within which a set of instructions for causing the machine to perform any one of the methodologies discussed herein below may be executed. In alternative embodiments, the machine may comprise a network router, a network switch, a network bridge, personal digital assistant (PDA), a cellular telephone, a web appliance or any machine capable of executing a sequence of instructions that specify actions to be taken by that machine.

The computer system 100 includes a processor 102, a main memory 104 and a static memory 106, which communicate with each other via a bus 108. The computer system 100 may further include a display unit 110, for example, a liquid crystal display (LCD). The computer system 100 also includes an alphanumeric input device 112, for example, a keyboard; a cursor control device 114, for example, a mouse; a disk drive unit 116, a signal generation device 118, for example, a speaker, and a network interface device 128.

The disk drive unit 116 includes a machine-readable medium 124 on which is stored a set of executable instructions, i.e. software, 126 embodying any one, or all, of the methodologies described herein below. The software 126 is also shown to reside, completely or at least partially, within the main memory 104 and/or within the processor 102. The software 126 may further be transmitted or received over a network 130 by means of a network interface device 128.

In contrast to the system 100 discussed above, a different embodiment uses logic circuitry instead of computer-executed instructions to implement processing offers. Depending upon the particular requirements of the application in the areas of speed, expense, tooling costs, and the like, this logic may be implemented by constructing an application-specific integrated circuit (ASIC). Such an ASIC may be implemented with CMOS (complementary metal oxide semiconductor), TTL (transistor-transistor logic), VLSI (very large scale integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs executed upon some form of processing core (such as the Central Processing Unit of a computer) or otherwise implemented or realized upon or within a machine or computer readable medium. A machine-readable medium includes any mechanism for storing or transmitting information in a form readable by a machine, e.g. a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information. Additionally, a machine-readable medium may be understood to mean a non-transitory machine-readable medium.

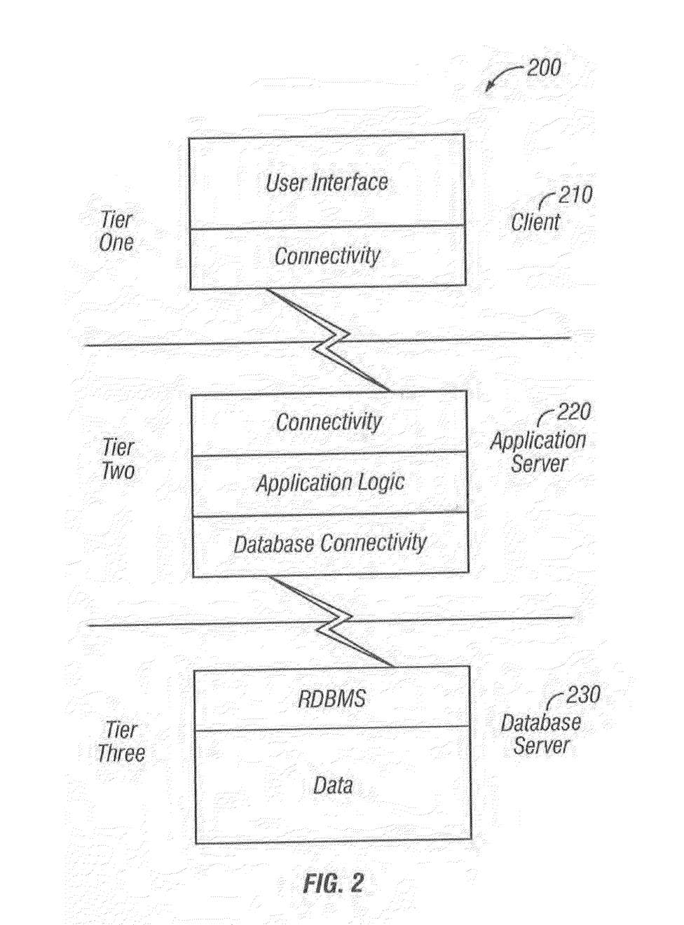

Referring now to Fig.2, shown is a block diagram of a client-server architecture 200 over which at least one embodiment is implemented. In overview, the client-server architecture separates the various processes of an application into separate tiers, or layers. In an embodiment, each tier is housed separately from the other tiers on a separate device. In other embodiments, the tiers may be distributed across computing devices in other ways. In additional embodiments, the tiers may all be housed on a single computing device. As shown in FIG. 2, a client-server architecture may include a client 210, an application server 212, and a database server. 214. As shown in FIG. 2, the client 210 may house the presentation layer, or user interface. In an embodiment, the user interface may be made up of a number of pages that one can access with a browser-type application. By interacting with the presentation layer or user interface, the user requests data from the database by entering input via various user interface elements. Additionally, the user, via the user interface is able to input data upon which the application layer may act, and which may also be saved to the database 214. Also, by means of the user interface, the user views data returned by the system in response to the user request.

The application server may house the application logic, such as game rules and functional modules that actually process data. Thus, the application layer provides most of the functionality specific to the present system and method. The application layer, however, does not store persistent data. In an embodiment, the presentation layer and the application server may both reside on a single device.

Finally, the database server 214 may house a database management system and a database for processing and storing persistent data. In addition to the foregoing, the various tiers or layers also incorporate connectivity elements for communicating with the adjacent tiers or layers.

In an embodiment, the client 210 may be a handheld wireless device such as a smartphone, upon which at least the presentation layer is implemented. In the present embodiment, the wireless device may communicate wirelessly with the Application layer 212. In an embodiment, both the presentation and the application layers reside on the wireless device, wherein the wireless device communicates via a wireless connection to a network containing the database layer 214. While a wireless handheld client potentially offers players great convenience and flexibility, allowing them to immediately enter plays and to receive results of their plays, in additional embodiments, a client may be a free-standing terminal, either wireless or wired. Additionally, in other embodiments, the client 210 may be a handheld computer, a laptop computer, or even a desktop computer upon which at least the presentation layer has been implemented.

In an embodiment, the database that orchestrates behind the scenes stores the data which drives game play.

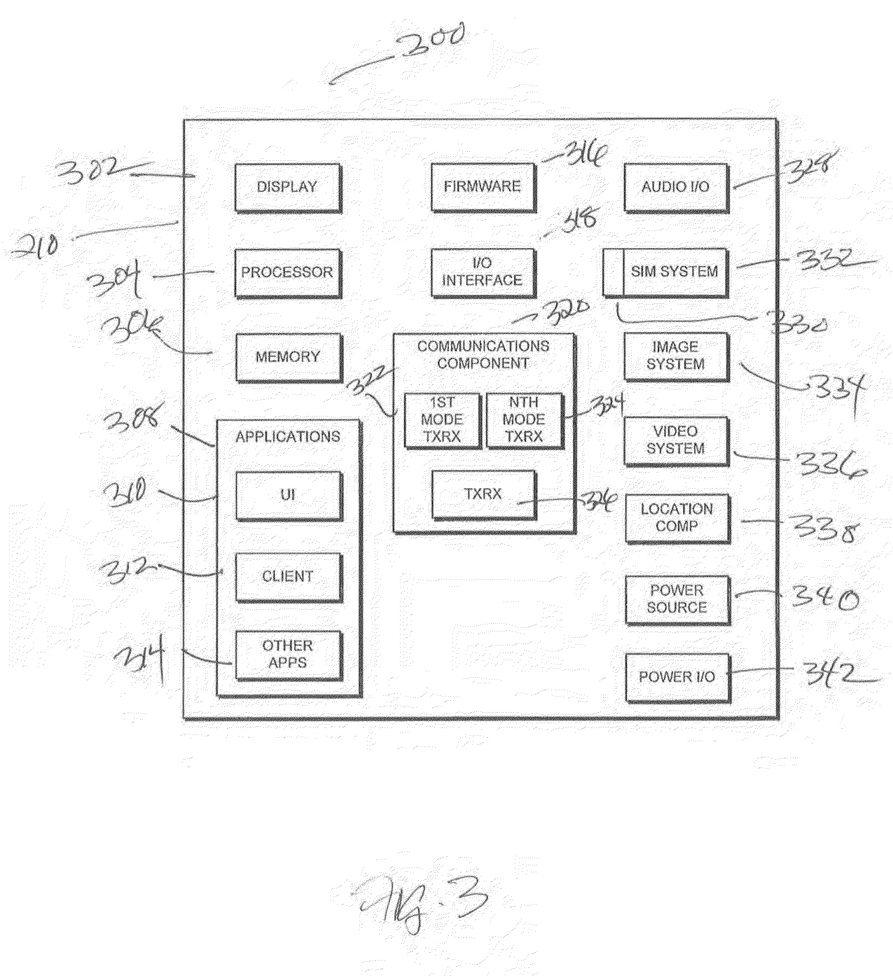

Referring to FIG. 3, provided is a schematic block diagram of a wireless client 210, as originally shown in FIG. 2. In embodiments, the wireless client 210 may be, for example, a smartphone or a dedicated mobile gaming device.

Although connections are not shown between all of the components illustrated in FIG. 3, the components can interact with each other to carry out device functions. In some embodiments, for example, the components are arranged so as to communicate via one or more busses (not shown). It should be understood that FIG. 3 and the following description are intended to provide a general understanding of a suitable environment in which the various aspects of some embodiments of the present disclosure may be implemented.

In at least one embodiment, the wireless client 210 includes a display 302 for displaying multimedia such as, for example, virtual objects, virtual object trajectories, application graphical user interfaces (GUIs), text, images, video, telephony functions such as Caller ID data, setup functions, menus, music, metadata, messages, wallpaper, graphics, Internet content, device status, preferences settings, map and location data and so on. In at least one embodiment, the wireless client 210 may also include a processor 304 for controlling, processing data, and/or executing computer-executable instructions of one or more applications including one or more asynchronous multi-user mobile gaming applications such as, for example, an asynchronous multi-user mobile Guild Game.

In at least one embodiment, the wireless client 210 may also include a memory 306 for storing data and/or one or more applications 308, such as the Guild Game application. In some embodiments, the memory 306 may store information associated with determining location of the wireless client 210.

In at least one embodiment, the applications 308 may include a user interface (UI) application 310. In at least one embodiment, the UI application 310 may interface with a client application or operating system (OS) 312 to, for example, facilitate user interaction with device functionality and data. In some embodiments, the OS 112 may be, for example the APPLE IPHONE OS (APPLE CORPORATION, Cupertino, Calif.), or Google ANDROID OS (GOOGLE, Inc., Mountain View, Calif.). These operating systems are merely exemplary of the operating systems that may be used herein.

In at least one embodiment, the UI application 310 may aid the user in entering message content, viewing received messages, answering and/or initiating calls, entering and/or deleting data, entering and setting user IDs and passwords, configuring settings, manipulating address book content and/or settings, interacting with other applications 314, and so on and may aid the user in inputting selections and maneuvers associated with one or more games as herein described.

In at least one embodiment, the other applications 314 may include, for example, add-ons, plug-ins, location applications, e-mail applications, music applications, video applications, camera applications, power conservation applications, game applications, productivity applications, entertainment applications, enterprise applications, customer information management applications, accounting applications, authentication applications, applications, proprietary business applications, combinations thereof, and the like. In at least one embodiment, the applications 308 may be stored in the memory 306 and/or in a firmware 316, and may be executed by the processor 304. The firmware 316 may also store code for execution during client 210 power up, for example.

In at least one embodiment, the wireless client 210 may also include one or more input/output (I/O) interfaces 318 for input/output of data, such as, for example, user IDs, passwords, and application initiation (start-up) requests. In some embodiments, the I/O interface 318 may be a hardwire connection, such as, for example, a USB, mini-USB, audio jack, PS2, IEEE 1394, serial, parallel, Ethernet (RJ48) port, RJ11 port, or the like. In some embodiments, the I/O interface 318 accepts other I/O devices such as, for example, keyboards, keypads, mice, interface tethers, stylus pens, printers, thumb drives, touch screens, multi-touch screens, touch pads, trackballs, joysticks, microphones, remote control devices, monitors, displays, liquid crystal displays (LCDs), combinations thereof, and the like. It should be appreciated that the I/O interface 318 may be used for communications between the wireless client 210 and one or more network or local devices, instead of, or in addition to, a communications component 320.

In at least one embodiment, the communications component 320 may interface with the processor 304 to facilitate wired and/or wireless communications with external systems. Example external systems include, but are not limited to, peer-to-peer networks, intranets, network databases, network storage systems, cellular networks, location systems, Voice over Internet Protocol (VoIP) networks, local area networks (LANs), wide area networks (WANs), metropolitan area networks (MANs), personal area networks (PANs), and other networks.

In at least one embodiment, the external systems are implemented using WIFI, WIMAX, combinations and/or improvements thereof, and the like. In some embodiments, the communications component 320 may include a multi-mode communications subsystem for providing cellular communications via different cellular technologies. In some embodiments, for example, a first cellular transceiver 322 operates in one mode, such as, Global System for Mobile communications (GSM), and an Nth cellular transceiver 324 operates in a different mode, such as Universal Mobile Telecommunications System (UMTS), while only two cellular transceivers 322, 324 are illustrated, the wireless client 210 may include more than two transceivers.

In at least one embodiment, the communications component 320 may also include a transceiver 326 for use by other communications technologies such as, for example, WIFI, WIMAX, BLUETOOTH, infrared, infrared data association (IRDA), near field communications (NFC), RF, and the like. In some embodiments, the communications component 320 may also facilitate reception from terrestrial radio networks, digital satellite radio networks, Internet-based radio services networks, combinations thereof, and the like. In at least one embodiment, the communications component 320 may process data from a network such as, for example, the Internet, an intranet, a home broadband network, a WIFI hotspot, and the like, via an ISP, DSL provider, or broadband provider.

In at least one embodiment, audio capabilities for the wireless client 210 may be provided by an audio I/O component 328 including a speaker to output audio signals and a microphone to receive audio signals.

In at least one embodiment, the wireless client 210 may also include a slot interface 330 for accommodating a subscriber identity system 332 such as, for example, a subscriber identity module (SIM) card, a universal SIM (USIM) card, or a universal integrated circuit card (UICC). Alternatively, the subscriber identity system 332 may be manufactured into the wireless client 210, thus rendering the slot interface 330 unnecessary. In at least one embodiment, the subscriber identity system 332 may be programmed by a manufacturer, a retailer, a user, a computer, a network operator, or the like.

The wireless client 210 may also include an image capture and processing system 334 (image system). Photos can be obtained via an associated image capture subsystem of the image system 334, for example, a camera. The wireless device 210 may also include a video system 336 for capturing, processing, recording, modifying, and/or transmitting video content.

In at least one embodiment, the wireless client 210 may also include a location component 338 for use in determining geographic location of the wireless client 210. The location component 138 may include, for example, a GPS receiver.

In at least one embodiment, the wireless client 210 may also include a power source 340, such as batteries and/or other power subsystem (AC or DC). The power source 340 may interface with an external power system or charging equipment via a power I/O component 342.

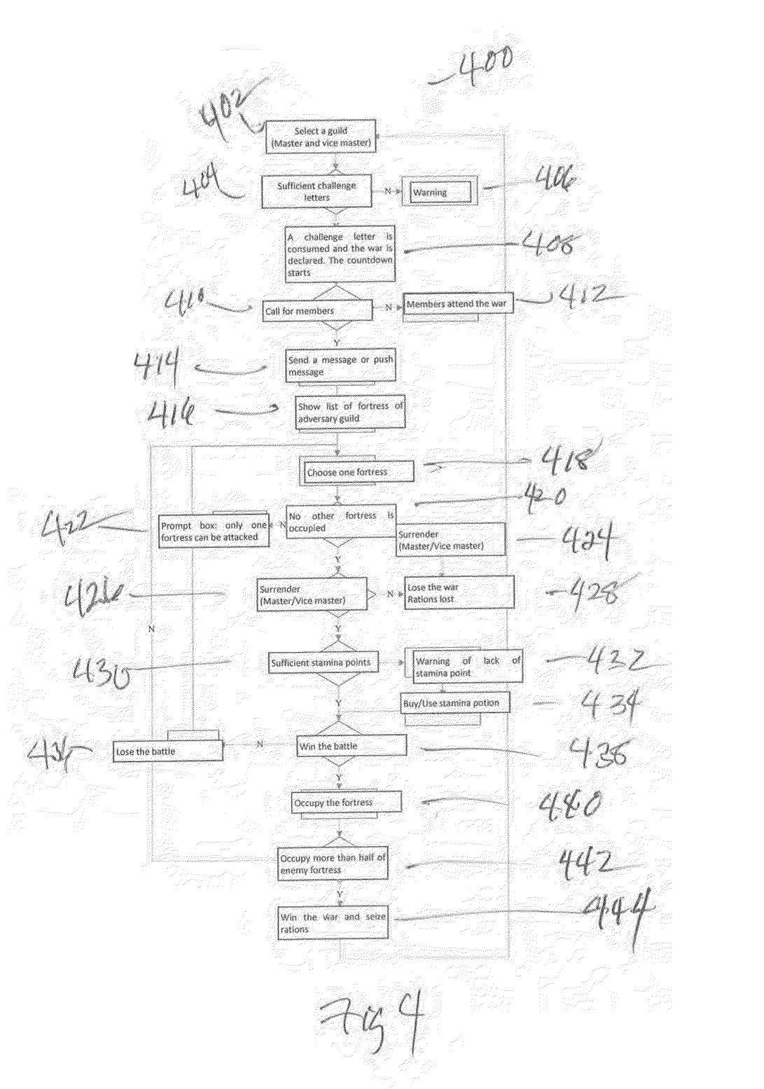

Referring now to FIG. 4, shown is a flow diagram 400 of the game play for an embodiment of an asynchronous mobile multiplayer Guild Game. In at least one embodiment, the process of game play may include at least one of the following steps and sub-steps:
Select a guild 402;
Sufficient challenge letters 404;
Warning 406;
A challenge letter is consumed and the war is declared. The countdown starts. 408;
Call for members 410;
Members attend the war 412;
Send a message or push message 414;
Show list of fortresses of adversary guild 416;
Choose one fortress 418;
No other fortress is occupied 420;
Prompt box: only one fortress can be attacked 422;
Surrender (Master/Vice Master) 424;
Surrender (Master/Vice Master) 426;
Lose the war-rations lost 428;
Sufficient stamina points 430;
Warning of lack of stamina point 432;
Buy/use stamina potion 434
Lose the battle 436;
Win the battle 438;
Occupy the fortress 440;
Occupy more than half of enemy fortress 442; and
Win the war and seize rations 444.

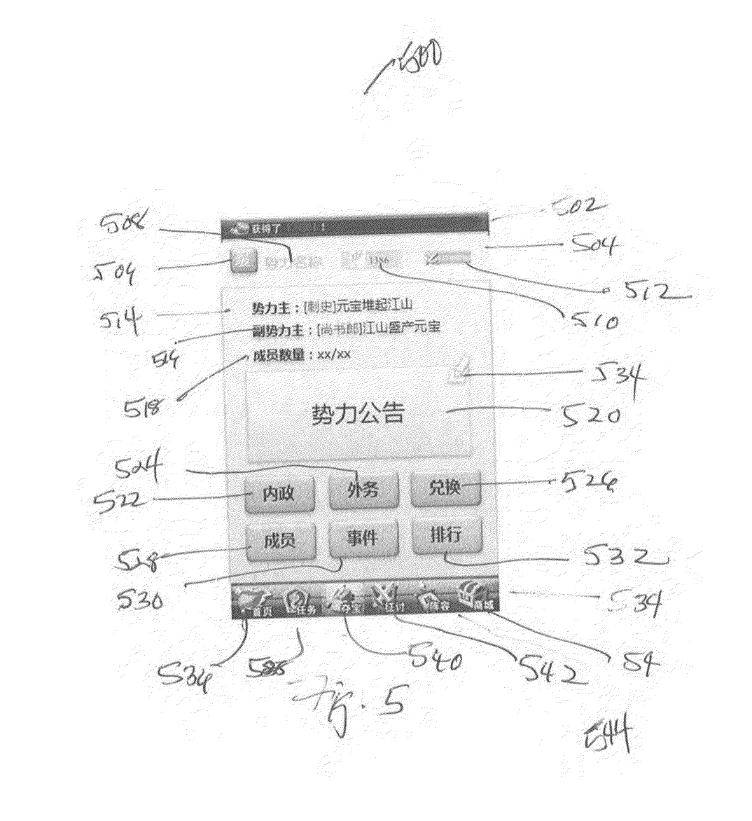

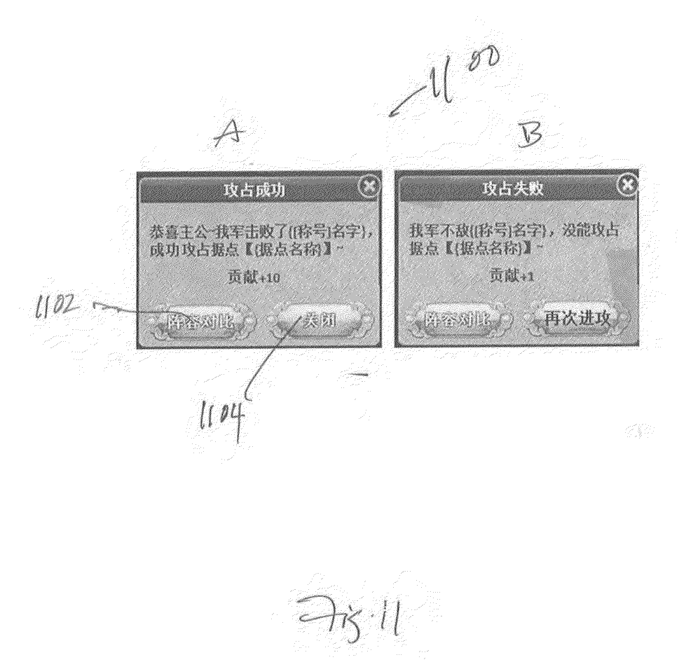

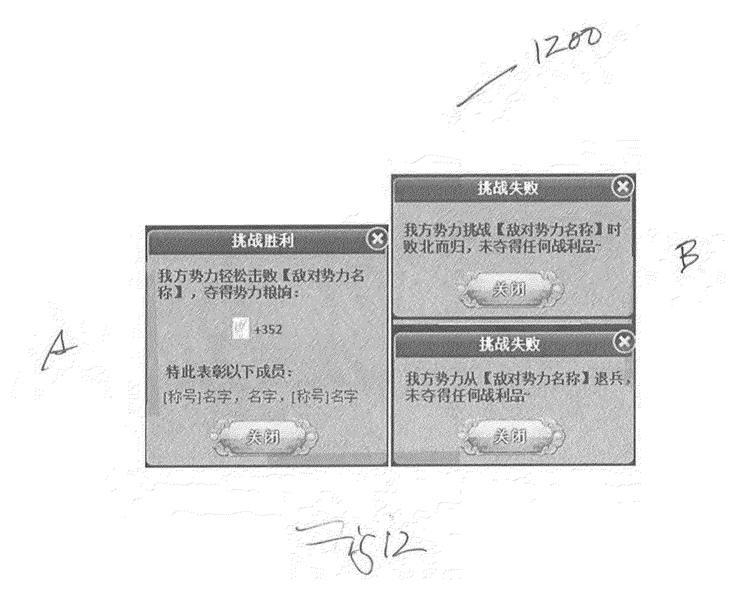

Herein below, each of the above steps and sub-steps are described in detail in relation to the UI, as shown in FIGS. 5-12.

Referring now to FIG. 5, shown is a Guild home page 500, which lists the properties and attributes of an individual Guild and grants the user access to various operations and functionalities having to do with the Guild, the operations and functionalities being organized by category, as described herein below.

At the top of the Guild page 500, a name bar 502 identifies the current user. Situated below the name bar 502 is the basic information bar 504 for the Guild, listing some of the major attributes of the Guild:
[Guild Level] 506;
[Guild Title] 508;
[Rations] 510; and
[Challenge Letter] 512.

Situated beneath the basic information bar 504 is a listing naming:
the Guild master [Cishi] 514, e.g. Yuanbao Duiqi Jiangshan;
the vice Guild master [Shangshulang] 516, e.g. Jiangshan Shengchan Yuanbao; and
the team member 518.
A Guild Notice is a board 520 or an invisible box, indicating the notices of such Guild, e.g. such as the notice board of QQ groups; there is a pencil icon 534 on the upper right of the board, which may be in either of two states: it is in a bright color when editable and in a subdued color when not editable. Modification of notices is further described herein below.

Guild Attribures
Level 506: Decides the maximum number of members, officials, fortresses, and tasks, and changes according to consumption of rations;
Member 508—Determined by Guild Level. In at least one exemplary embodiment, the maximum number of members is equal to Guild level +29. It will be appreciated that the permissible number of guild members is variable as a matter of design;
Rations 510—Rations represent properties held by the Guild, and can be obtained by successfully accomplishing tasks by Guild members or by starting wars against other guilds. They can be used to upgrade the Guild or distributed by the Guild master to Guild members;
Accumulative rations 510 obtained: the accumulative rations obtained by the Guild through tasks and wars; the value only increases and does not decrease once increased;
Challenge letter 512: The Challenge letter is an indicator of a Guild's power and strength and may not exceed an upper limit. It will be appreciated that ‘challenge letter’ is a variable design parameter. Additionally, the number of challenge letters increases, up to the maximum number, by one after a predetermined time period. It will be appreciated that the time period is a variable design parameter;
Number of officials: the maximum number of officials that can be appointed by the Guild Master;
Number of Fortresses: the number of forces that can be deployed in defense positions. When one guild declares a war against another guild, the declaring Guild may attack the fortress of the other Guild. The number of fortresses is determined by the level of such Guild;
Number of tasks: the number of tasks that can be executed by a Guild member of the Guild; determined by the Guild level;
Country—the country to which the Guild belongs.

Referring back to FIG. 5, a plurality of buttons, 522-532 grant the player access to a number of functional categories related to the Guild: Domestic Affairs 522, Foreign Affairs 524, Trade 526, Member 528, Event 530, and Rating 532.

In at least one embodiment, the Guild screen 500 may include a tool bar 534 having the options, for example: Home 536, Task 538, Treasure 540, Battle 542, Deployment 544, and Shop 546.

Player Attributes (Not Shown)
Guild: changes whenever the player quits or joins a Guild;
Contribution: used to evaluate the contribution made by a player to the guild through tasks and ware. Contribution may be cleared when the player quits a Guild and may start with zero when a player joins or rejoins a guild;
Position: describes the position of the player in the guild, such as Master, First-class minister, Second-class minister, and Third-Class minister; cleared when a player leaves a guild.
Title: related to Guild level and position of the player; for example, as the guild level increases, a player may be granted titles such as Cishi, Zhoumu, Langliang, and so on. Typically, a player may have only one title, i.e. the highest grade, by default. It is not cleared but players can only trade them in a guild.
Rations: personal properties of the player; obtained when the guild master distributes guild rations to members. They may be used to trade for items that cannot be bought directly. When a player quits a guild, the rations are not cleared, but players can only trade them in a Guild.

Guild Wars

Defense Deployment

Clicking on the [Foreign Affairs] button 524 on the Guild home page 500 allows entry to the Guild ward page 600. By default, the [Battle] page A is displayed; clicking on the [Defense] 604 button, shows the list of fortresses 608 of the Guild in question. Additional buttons available for selection are [Battle] 602 and [Return] 606.

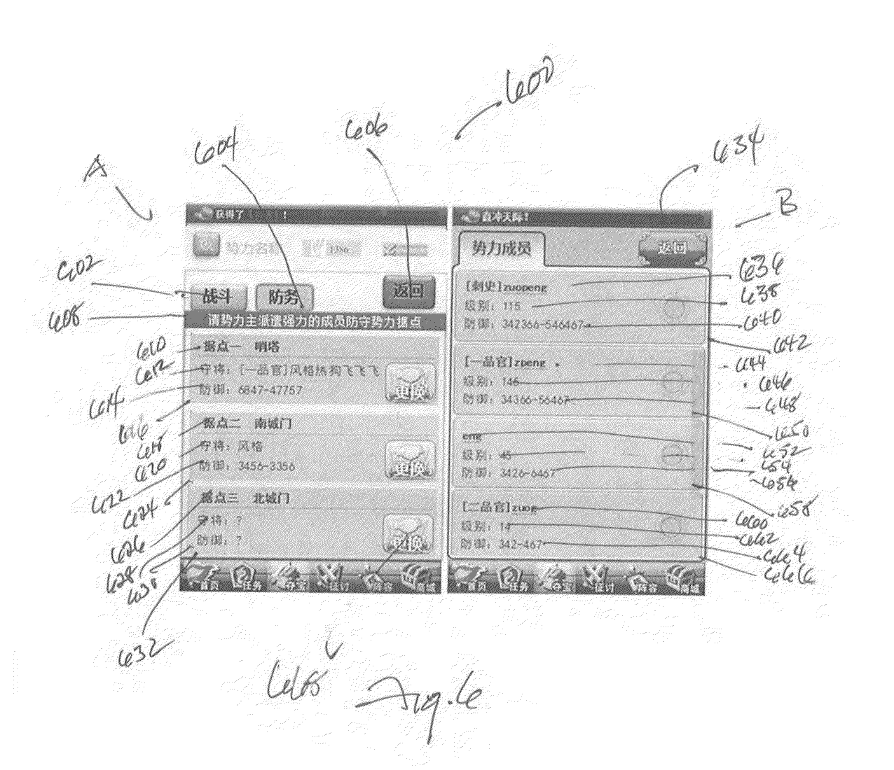

In FIG. 6, the records 616, 624, 632 of three Fortresses are displayed:
Fortress 1 “Watchtower” 610, having defender [First-class minister] “Fengge Feifeifei” 612 and listed defense “3456-3356” 614;
Fortress 2 “Watchtower” 618, having defender “Fengge” 620 and no listed defense “3456-3356” 622;
Fortress 3 “North Gate” 626, having no defender 628 and no listed defense 630.

As above, Fortress attributes may include Fortress name, defender and defense. In at least one embodiment, the number of Fortresses is related to the Guild level. It will be appreciated that the number of Fortresses and their names is a variable design parameter.

The name and title of the defender is displayed in field “Defender” and a defense value is displayed in the field of “Defense”. If the defender of the fortress is null, a question mark, “?”, is displayed both in the “Defender” field and the “Defense” fields.

Only the Guild master can change the defender of a fortress. When any player other than the Guild master is on the page 600, the [Change] button 668 is disabled and cannot be clicked. Additionally, a message can be displayed at the head of the Guild list 608, such as “My lord, only the guild master can change the fortress defender.”

After the guild master clicks on [Change] 668, the screen jumps to the page 600B. A listing 634 of Guild members available to be named as defenders is displayed. Only available Guild members are listed. Those already named as defenders are not included in the list. Shown are member records 642, 650, 658, and 666:
Name: [cishi] Zuopeng 636; level 115 (638) and defense number 34266-546467 (640);
Name: [first-class minister] Zpeng 644; level 145 (646) and defense number 34266-546467 (648);
Name: eng 652; level 45 (654) and defense number 3426 -6467 (656);
Name: [second-class minister] Zuog 660; level 14 (662) and defense number 342-467 (664).

If a member defending a fortress quits (actively or passively), the fortress he/she defends becomes a fortress without any defense.

Declare a War

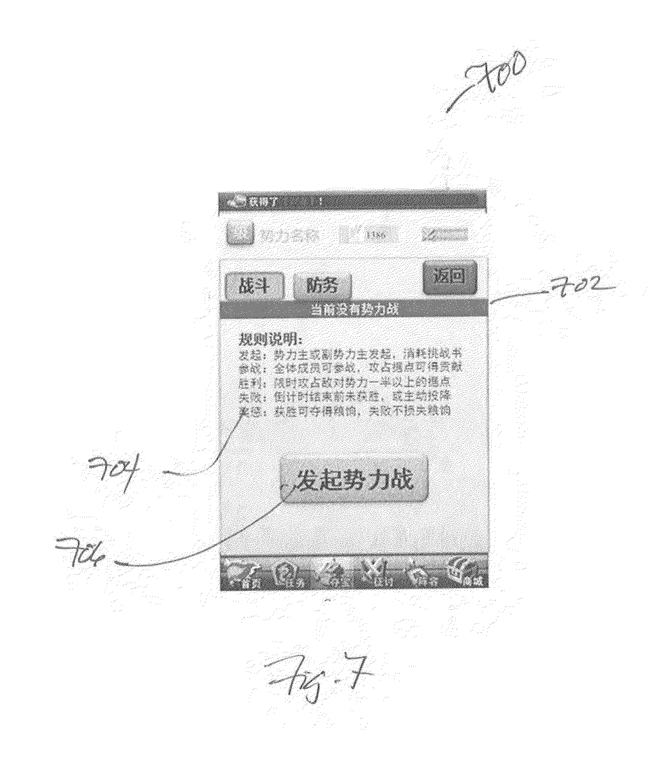

Referring now to FIG. 7, a screen 700 is shown for declaring a war. In actuality the screen 700 can be navigated to by selection of the battle option 542 from the toolbar at the bottom of the Foreign Affairs page 600. As shown in FIG. 7, if a war is not currently in progress, the [Foreign affairs—battle] page 700 is as shown. If a player is not the Guild master, the [Declare a war] button 706 is greyed-out and disabled and displays a message box: “Only the master and vice master can declare a war”. Additionally, a Guild notice 702 states, “There is no Guild war for the moment.” The text of the Guild notice also summarizes the rules in the event a war is declared:
“Declare a war: A war shall be declared by guild master or vice master and a Challenge Letter is used”;
“Attend a war: The war may be attended by any member and contribution is made by attacking and taking down a fortress”;
“Win: Occupy more than half of the fortress of the enemy within a time limit”;
“Lose: The attacking party fails to win the war before the countdown is over and surrenders to the enemy”;
“Bonus and Punishment: Rations are obtained from the enemy if the attacking party wins and no rations are lost if the attacking party loses”.

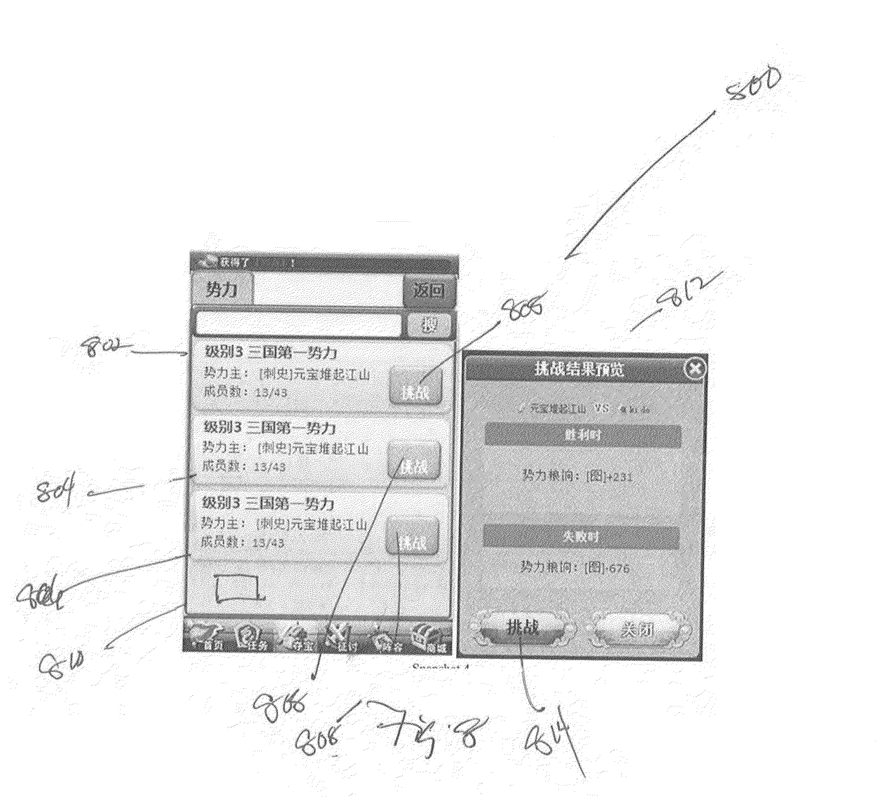

When a Guild master or vice master clicks on the [Declare a war] button 706, the screen jumps to the list of guilds 800 as show in FIG. 8. In the list of adversary guilds 800, a number of guilds may be listed according to certain rules.

Level of adversary guild. As shown in FIG. 8, each of the adversary guilds are level 3 Guilds.

At the end of the list of adversary guilds, clicking on the [Refresh] button 810 refreshes the list of Guilds.

Clicking on [Challenge] 808 in a guild record displays a challenge result preview message 812: the rations to be obtained (231) if the war is won and the rations that may be lost if the war is lost (676) are calculated according to a formula which may be, in an embodiment, a percentage of the rations obtained, e.g. 20% of the rations.

When a player clicks on the [Challenge] button 814 in the challenge result preview 812, the system judges if the player's guild has conquered such target guild a predetermined number of times within the past day, for example, three times. If yes, the operation is ceased and a prompt box may be displayed, title: “Message”; Description: “My Lord, we have attacked this guild three times (only active attacks) in a day, please show your mercy”; button 1: “Close”; button 2: X.

If the player's guild conquered the guild less than three times, the system judges if the guild is attacking any other guild, if yes, the original prompt box is closed and new one is displayed, title: “Message”; Description: “My Lord, we are attacking [{name of guild being attacked}], and can only start one war at the same time”; button 1: “Close”, button 2: “X”. Click on “Close” or “X” to close the prompt box and to return to refreshed Guild war page.”

If player's guild is not attacking any other guild for the moment, the system judges if there are sufficient [Guild attributes—Challenge Letter]; if not, a prompt box appears to buy and use [Items—Challenge Letter).
Message: “My Lord, we have insufficient challenge letters to declare a war! <br>•Obtaining a Challenge Letter: {countdown}<br>•Obtaining all challenge letters: {Countdown}<br>{Information of Challenge Letter}<br>Price: {Price of Challenge Letter}”
Button 1: “Use/buy”, button 2: “Close”, button 3: “X”.
Each [Item—Challenge Letter] can be used to obtain 1 point of [Attribute—Challenge Letter].

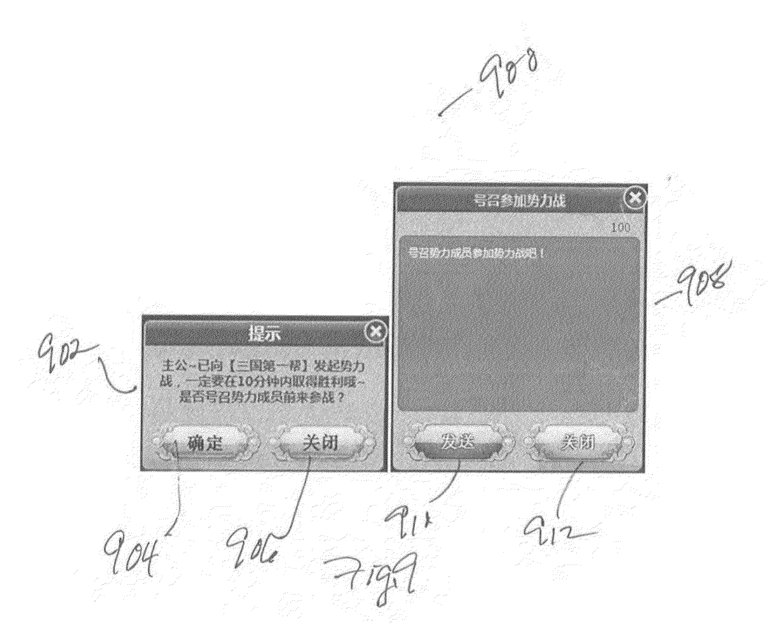

If there are sufficient Challenge Letters, a war is declared, consuming a [Attribute—Challenge Letter], and a message is sent to all members at the same time a prompt box 902 appears, calling for members of the guild to attend the war, as in FIG. 9. As shown in FIG. 9, the message in the prompt box 902 contains text, such as, for example, “My Lord, we have declared a war against [Sango Diyi Bang] and we must win the war in ten minutes—Will you call for members to attend the war?” The player selects either [Yes] 904 or [No] 906.

If [Item—Challenge Letter] is open to players (When the function is promoted, players can only buy Challenge Letters when their Challenge Letters are insufficient), all members may buy and use challenge letters under [Shop—Item]. When it is successfully used, a message appears “Successfully used, and the Challenge Letter of the Guild is increased by 1”; if otherwise, a message appears “Failed, the Challenge Letter number of the Guild has reached the upper limit”.

Call for Members

Clicking on the “yes” button 904 in FIG. 9 may cause an input box 908 to appear. As shown in FIG. 9, the input box may bear a caption such as, for example, “Call for members.”

Clicking on the “Send” button 910 of the box of 908 causes a personal message of [Message—Battle] to all Guild members. If a member is not online, the system may push the message to the member that is not online. By clicking on [Close] 912, the system is prevented from sending any [Message—Battle] and push information. Nonetheless, a Guild message is still sent.

Description of [Message—Battle]: “{[Title] name} has declared a challenge against [{name of the adversary}], and calls for you to attend the battle! <br>He/She says, {input information}”. Button 1: “Attend”, Button 2: “Close”, Button 3: “X. Click on [Attend] to jump to ‘Foreign affairs—Battle] page of the guild.

Attend a War

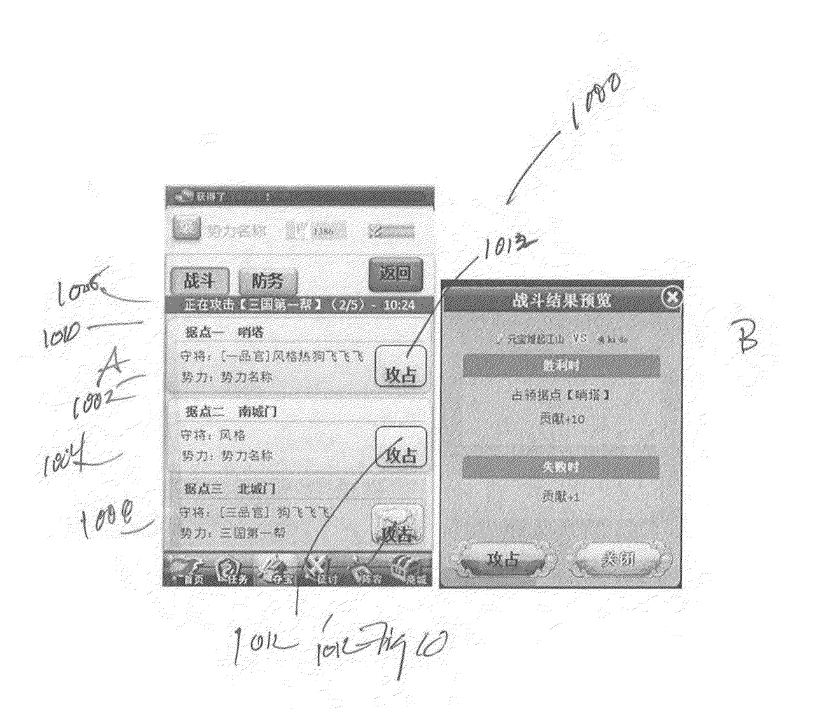

After a war is declared, a [Foreign affairs—Battle] page 1000 (A) is displayed, as shown in FIG. 10.

The bar 1008 on the list of fortresses 1010 of the adversary indicates: “Attacking [{name of adversary guild}] ({number of fortresses taken by our guild}/{number of fortresses of adversary guild}—{Remaining time}”. Here, the attacking Guild is “Sanguo Diyibang”; the {number of fortresses taken by our guild}/{number of fortresses of adversary guild}=⅖; and the {Remaining time}=10:24. If a fortress of the adversary guild is taken, the box of such fortress (1002-1006) is highlighted, for example by being shown in a light color; and [Attack] button 1012 subdued, for example by being shown in gray tones, and a message appears when clicking on the button 1012: “My Lord, we have taken this fortress.”

Clicking on the [Attack] button 1012 on the fortress 1002, 1006 which is not taken by the guild, causes the system to judge if the player has attacked any other fortress. If yes, a prompt box appears. Title: “Message”; Description: “My Lord, you have taken [{name of fortress taken}], and cannot attack another fortress”; button 1: “Close”; button 2: “X.” If a player has not taken any other fortress, the system determines if his remaining stamina value ≧1. If yes, a prompt box of “Battle result preview,” as shown in the right snapshot above, appears, if not the system reminds the player of low stamina. A prompt box can be used to remind player to but items to recover stamina.

If, when a player clicks on the [attack] button 1012 on “Battle result preview”, the fortress is not taken yet, 1 stamina point is consumed and the system makes a determination on the battle result. If the attacking side wins, it takes the fortress and obtains 10 contribution points. The prompt box 1000B is shown in FIG. 10.

If the fortress does not have a defender, “?” is shown in fields of “Defender” and “Guild”. The same information is shown in the prompt box of the Battle result preview, e.g. see FIG. 6.

As shown in FIG. 10B, when a player attacks an unguarded fortress, the message is “Congratulations, we have taken [{name of fortress}]˜<br>contribution+10”. Button 1 1102: Close”; button 2 1104: “X.”

War Result

In at least one embodiment, the front end requests are refreshed from the back end at predetermined intervals, every 10 seconds, for example. When a side has taken more than 50% of their enemy's fortresses, they win the war and a prompt box “Win the challenge” 1100 A appears; if a side does not win the challenge before the countdown is finished, a prompt box 1100B, “Lose the challenge” appears. If the master or vice master of a Guild chooses to surrender, a “Lose the challenge” prompt also appears.

If, when the countdown finishes, no player is viewing the Guild war page, the win/lose judgment may not be triggered at once and is triggered when any member accesses the guild war page.

A [Retreat] button is shown at bottom of the fortress list of an adversary Guild, but it is not shown if the player is not the Master or Vice master of the guild. When the Master or Vice master of the guild clicks on [Retreat], a prompt box appears for confirmation, Title: “Message”; Description: “You will lose the war if you retreat. Do you want to retreat?” Button 1: “OK”; button 2: “Close”; button 3: “X”.

A message is sent to all members regardless of the results of the war. See the description herein with regard to Win a war and Lose a war for more information.

During a guild war, if the guild being attacked is dissolved, the attacking side wins the war and a message 1200A appears, title: “Win”; Description: “Our great troops have knocked out this guild and taken their rations: <br>{icon of rations}+{quantity}”; button 1: “Close”; button 2: “X.”

In the event that the war is lost, a message 1200B appears “Our army was defeated by {[Title name}, and failed to take fortress [{Fortress name}]—Contribution+1.”

Rations

In at least one embodiment, there may be two records of rations for a guild, for example, Part A and Part a.

Among all rations, Part A may not be seized by other guilds, while Part a may be seized. When the system calculates the quantity of rations seized by a Guild, the calculation is based on Part a.

When the Guild master chooses to upgrade or distribute rations, the system consumes rations in Part A first; when rations in Part A are insufficient, it consumes those in Part a.

When a member completes a task, assuming that the member gains m points of rations, then Part A is increased by m/2, which is rounded down. In its turn, Part a is also increased by m/2, which is rounded up.

When a guild wins or loses a war, assuming that it obtains ±n rations, rations in Part A change by 0, while rations in Part a change by ±n.

Rations gain/loss is calculated according to the algorithm below:
Set the level of attacking guild as ‘x’ and the level of guild attacked as ‘y’.
Set the quantity of rations held by attacking side, which can be seized by the other guild as ‘a’, and set the quantity of rations held by attacked side, which can be seized by the other guild as ‘b’.

TABLE 1
RATION GAIN/LOSS

| | | | Defending side | |
|---|---|---|---|---|
| | Attacking side | | wins the war | |
| | wins the war | | | Attacked |
| | Attacking side | Attacked side | Attacking side | side |
| x-y | obtains | loses | loses | obtains |
| −4 and | 9x + 15% b | 15% b | 0 | 0 |
| below | | | | |
| −3 | 8x + 13% b | 13% b | 0 | 0 |
| −2 | 7x + 12% b | 12% b | 0 | 0 |
| −1 | 6x + 11% | 11% b | 0 | 0 |
| 0 | 5x + 10% b | 10% b | 0 | 0 |
| 1 | 4x + 9% b | 9% b | 0 | 0 |
| 2 | 3x + 8% b | 8% b | 0 | 0 |
| 3 | 2x + 7% b | 7% b | 0 | 0 |
| 4 | x + 5% b | 5% b | 0 | 0 |

If the attacking side loses the war, neither the attacking side nor the defending side gain or lose anything.
If the attacking side wins the war and the seizable rations of the attacked side are insufficient, all remaining rations are seized by the attacking side and no negative value appears. Neither are any rations in the unseizable portion taken by the attacking side.
The quantity of rations seized is no greater than the level of a player's guild multiplied by 250.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

1. A computer-implemented method for real-time coordination of guild game play comprising:
a computer organizing a plurality of players into two or more guilds, wherein players comprise members of their respective guilds, said guild members cooperating to achieve a set objective for their guild within a predetermined time period in a virtual conflict with at least one other guild;
a computer receiving inputs comprising a strategy for achieving said set objective in an impending battle for each side in the conflict, the inputs entered by one or more leaders of one or more of said guilds;
at least some of a plurality of mobile devices used by at least some of said players receiving notification of said impending conflict, said notification being sent by said computer after being entered by one or more of the leaders;
at least some of a plurality of mobile devices receiving inputs asynchronously entered by each of a plurality of players in execution of the strategy;
the at least some of the plurality of mobile devices transmitting each of the asynchronously-received player inputs to a computer;
the computer coordinating in real time said asynchronously received player inputs transmitted from the at least some of the plurality of mobile devices so that game play proceeds in real time based on the asynchronously-entered inputs in accordance with said strategy; and
the computer declaring a guild the winner of the conflict if said guild achieves said set objective within said predetermined time period.

2. The method of claim 1, wherein each guild comprises any of the following attributes:
guild level, which determines a maximum number of members, officials, fortresses, and tasks, and changes according to consumption of rations;
member, determined by guild level, defining a permissible number of guild members;
rations, which represent properties held by a guild, and which can be obtained by successfully accomplishing tasks by guild members or by starting wars against other guilds, wherein rations can be used to upgrade a guild or distributed by a guild master to guild members;
accumulative rations obtained by a guild through tasks and wars, wherein a value for accumulative rations only increases and does not decrease once increased;
challenge letter , which is an indicator of a guild's power and strength and which may not exceed an upper limit;
number of officials, which is a maximum number of officials that can be appointed by a guild master;
number of fortresses, which is a number of forces that can be deployed in defense positions, wherein when one guild declares a war against another guild, the declaring guild may attack the fortress of the other guild, and wherein the number of fortresses is determined by the level of a guild;
number of tasks, which is a number of tasks that can be executed by a guild member of the guild, as determined by the guild level; and
country to which the guild belongs.

3. The method of claim 2, wherein each player comprises any of the following attributes:
guild;
contribution, which used to evaluate a contribution made by a player to a guild through tasks and ware;
position, which describes a position of the player in a guild;
title, which is related to guild level and position of the player; and
rations, which comprise personal properties of a player; obtained when the guild master distributes guild rations to members, wherein rations may be used to trade for items that cannot be bought directly.

4. The method of claim 1, said battle comprising a guild war comprising:
defense deployment;
declaring a war;
issuing a call for members;
attending a war; and
determining a war result.

5. The method of claim 4, wherein defense deployment comprising:
displaying a battle page;
showing a list of fortresses of a guild in question; and
listing guild members available to be named as defenders.

6. The method of claim 4, wherein declaring a war comprising:
a guild master or vice master declaring a war and using a challenge letter;
wherein said war may be attended by any guild member and guild member contribution to achieving said objective is made by attacking and taking down a fortress of another guild;
where a win occurs by occupying more than half of the fortresses of an attacked guild within a time limit;
wherein a lose occurs when an attacking guild fails to win the war before a countdown is over and said attacking guild surrenders to said attacked guild;
wherein bonus and punishment rations are obtained from the attacked guild if the attacking guild wins; and
wherein no rations are lost if the attacking guild loses.

7. The method of claim 4, wherein issuing a call for members comprises:
sending a personal message to all guild members.

8. The method of claim 4, wherein attending a war comprises:
displaying a battle page showing a list of fortresses of an adversary that indicates the name of adversary guild that is being attacked and the number of fortresses taken by the attacking guild divided by a number of fortresses of the adversary guild minus remaining time; and
making a determination of a battle result;
wherein when the attacking guild wins, the attacking guild takes the fortress and obtains contribution points.

9. The method of claim 4, wherein determining a war result comprises:
refreshing requests received from attacking guild members asynchronously at predetermined intervals;
wherein when a guild has taken more than 50% of an attacked guild's fortresses, the attacking guild wins the war; and
wherein when an attacking guild does not win a challenge before a countdown is finished, the attacking guild loses the war.

10. The method of claim 2, wherein rations comprise:
two portions of rations for a guild, wherein among all rations, a first portion thereof may not be seized by other guilds, while a second portion may be seized;
wherein calculation of a quantity of rations seized by a guild is based on said second portion.

11. The method of claim 10, wherein ration gain/loss is calculated according to the following:
setting a level of an attacking guild and a level of a guild attacked;
setting a quantity of rations held by the attacking guild which can be seized by the other guild, and setting a quantity of rations held by attacked side, which can be seized by the other guild;
when the attacking guild loses the war, neither the attacking guild nor the defending guild gain or lose anything; and
when the attacking guild wins the war and seizable rations of the attacked guild are insufficient, all remaining rations of the attacked guild are seized by the attacking guild and no negative value appears, neither are any rations in an unseizable portion taken by the attacking guild;
wherein the quantity of rations seized is no greater than the level of a guild multiplied by a predetermined value.
